(19) United States
(12) Patent Application Publication
(10) Pub. No.: US 2020/0264456 A1
(43) Pub. Date: Aug. 20, 2020

(54) System and Method For Encapsulating Photonic Nanocrystals for Dynamic and Responsive Color Media

(71) Applicant: THE REGENTS OF THE UNIVERSITY OF CALIFORNIA, Oakland, CA (US)

(72) Inventors: Yadong YIN, Riverside, CA (US); R. Andrew DAVIDSON, Riverside, CA (US)

(73) Assignee: THE REGENTS OF THE UNIVERSITY OF CALIFORNIA, Oakland, CA (US)

(21) Appl. No.: 16/791,587

(22) Filed: Feb. 14, 2020

Related U.S. Application Data
(60) Provisional application No. 62/806,994, filed on Feb. 18, 2019.

(51) Int. Cl. G02F 1/01; G02B 1/00; G02F 1/23; G02F 1/09; A63B 71/06

(52) U.S. Cl. CPC G02F 1/0131; G02B 1/005; G02F 1/23; A63B 2071/0611; A63B 71/0605; G02F 2203/02; G02F 1/09

(57) ABSTRACT

A method and system are disclosed for generating a dynamic and responsive color media. The method includes encapsulating nanomaterials within a capsule to form encapsulated photonic crystals; and dispersing the encapsulated photonic crystals within a film or substrate, wherein the encapsulated nanomaterials retain a liquid dispersion state and can move freely within the capsule and the capsules containing photonic crystals remain stationary within the film or substrate.

### CROSS REFERENCE TO RELATED APPLICATIONS

This application claims the benefit of U.S. Provisional Application 62/806,994, filed Feb. 18, 2019, which is incorporated by reference in its entirety.

### FIELD OF THE INVENTION

The present disclosure generally relates to a system and method for encapsulating photonic nanocrystals for dynamic and responsive color media.

### BACKGROUND OF THE INVENTION

Photonic crystals are materials which exhibit colors though the process of diffraction, a unique physical mechanism different from that of traditional dyes and pigments. Diffraction by photonic crystals offers a range of advantages over traditional pigments such as producing a spectrum of colors from a single material which is not susceptible, for example, to the same “bleaching” phenomenon which may occur in dyes and pigments. This allows for manufacturing of a single material which can be used for many different colors and have a relatively longer lifetime. However, the use of photonic crystals industrially has not yet come to fruition, as there remain barriers to their employment.

Photonic crystals are utilized to produce responsive and fixed or tunable colors. These photonic crystals can be made into 1D, 2D, or 3D structures to produce various color or angular properties. Linear chains of magnetite nanoparticles fixed in place using a polymer or oxide material such as silica creates a 1D photonic crystal where a bright diffraction color can be observed from the tip of the chain vs. no color observed from a position normal to the chain. The use of photonic crystals as having a potential for inks due to their “ON” and “OFF” states which can be manipulated with a magnetic field due to the magnetite used in the photonic crystal was disclosed in U.S. Patent Publication No. 2014/0004275A1. Similarly, 2D and 3D lattice structures of aligned nanoparticles can be used to produce a larger number of crystal facets for diffraction with the potential to have different colors produced on each facet depending on the nanoparticle building blocks.

In order for photonic crystals to possess a dynamic range of color and responsiveness, the photonic crystal must be allowed to rotate, move position, or change size within the medium it is stored in. For many applications in which colors are applied, pigments and dyes are trapped into a dried solid or hardened medium. In the case of photonic crystals being used for their dynamic color properties, a new medium is to be recognized, one in which the geometry of the photonic crystal can be readily manipulated within the storage medium. One scenario which allows for this is an emulsion system where the suspended droplets containing photonic crystals are locked within the drying film-former. However, traditional film forming mixtures are designed to coalesce, as solvent evaporation occurs in order to form a solid film. This mechanism is in direct conflict with preserving an emulsion during film formation rendering most existing products unusable for a system having dynamic and responsive photonic crystal colors. In order to preserve the emulsion, it is necessary to form a shell or capsule wall around the suspended droplet containing photonic crystals. In the presence of a shell wall, the mechanism of coalescence is inhibited while the film-forming mixture continues its normal drying process, efficiently sealing the capsules into the film.

Utilizing microcapsules for the encapsulation of materials and preservation of a chemical environment is known, for example, see U.S. Pat. No. 2,897,165. Microcapsules are primarily used for the delivery of pharmaceuticals or agrochemicals which may have poor solubility, for example, see U.S. Pat. No. 4,534,783. More recently, microcapsules are being employed to create confined chemical environments for chemical storage, reactions, and functional environments. Reflective electronic ink displays utilize microcapsules to create pixels where materials can migrate through solution and respond to electric fields, albeit they are not sealed into a film, but sandwiched between solid layers. (See, for example, U.S. Pat. Nos. 6,120,839 and 6,262,833). Self-healing paints are being developed with microcapsules containing polymer precursors incorporated into them such that when the protective paint layer is broken the capsules release their contents to heal the surface damage, for example, see U.S. Pat. No. 7,723,405 B2.

A similar method of creating a sealed chemical environment involving the trapping droplets of an emulsion in a solid exists within a narrow class of chemical mixtures. In this scenario, fast polymerization techniques can preserve an emulsion upon curing without the assistance of a shell wall or capsule. The curing mechanism is critically important in avoiding coalescence and preserving the suspension and cannot be a simple solvent evaporation technique. In example, silicones, a unique class of polymers, which can be immiscible with various solvents, can be rapidly cured into a solid. The viscosity of some silicones is sufficient enough to form an emulsion stable over the length of the curing time for silicone enabling the trapping of suspended droplets. However, this approach has numerous drawbacks, the main problem being that it has limited chemical compatibility meaning only certain chemicals can be used in this manner and those chemical systems may not be compatible with the chemical or material system to be trapped. The emulsion-cure system is also not ideal for creating thin films and is more applicable to a thicker medium whereas a film-forming resin or polymer solution can create much thinner films and have microcapsules integrated into them. Furthermore, the silicone emulsion relies on viscosity rather than stabilizing surfactants which mean there is little control over the size and uniformity of droplets created and trapped.

Aside from the various methods of preserving an emulsion system, the chemical system must also be idealized for use with the photonic crystals of interest. Though not required, many nanomaterials of interest contain silicates and or metal oxides. In both these situations, the materials are susceptible to oxidation and or dissolution in certain solvent environments such as aqueous phases. This is a disadvantage from a long term stability standpoint as the activity/behavior of the photonic crystals may decay more quickly if their chemical environments are not carefully controlled.

### SUMMARY OF THE INVENTION

In consideration of the above issues, it would be desirable to have a system and method which allows for a variety of chemical systems and can greatly improve performance and applicability of photonic crystals. For example, capsules with shell walls which can be suspended into most solvent phases can be made using both polar and non-polar core phases giving the capsules a relatively larger range of customizability and applicability to various substrates.

In accordance with an exemplary embodiment, the disclosure relates to a system and method of encapsulating photonic crystals within a solid film or substrate such that the encapsulated nanomaterials retain their liquid dispersion state and can move freely within their sealed capsules while the capsules themselves remain stationary within the solid substrate. The encapsulated photonic crystals can consist of a range of nanomaterial building blocks capable of forming colors by means of an applied external energy source, for example, a magnetic or electric field.

A method is disclosed for generating a dynamic and responsive color media, the method comprising: encapsulating nanomaterials within a capsule to form encapsulated photonic crystals; and dispersing the encapsulated photonic crystals within a film or substrate, wherein the encapsulated nanomaterials retain a liquid dispersion state and can move freely within the capsule and the capsules containing photonic crystals remain stationary within the film or substrate.

A method is disclosed for generating a dynamic and responsive color media, the method comprising: dispersing a photonic material in a solvent, the photonic crystals being encapsulated in a material shell forming microcapsules, the material shell acting a as a barrier, which protects the photonic material-solvent dispersion from phase mechanics and an exterior environment; mixing the photonic material-solvent dispersion with a film-former or substrate; and applying the photonic material-solvent dispersion with the film-former or substrate to an object and drying or curing the photonic material-solvent dispersion with the film-former or substrate to seal the photonic material in a hardened film or substrate.

A system is disclosed for generating a dynamic and responsive color media, the film or substrate comprising: nanomaterials encapsulated within a capsule to form encapsulated photonic crystals; and wherein the encapsulated photonic crystals are dispersed within a film or substrate, and wherein the encapsulated nanomaterials retain a liquid dispersion state and can move freely within the capsule and the capsules containing the photonic crystals remain stationary within the film or substrate.

It is to be understood that both the foregoing general description and the following detailed description are exemplary and explanatory and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is an illustration of an equilibrium “OFF” state having a random orientation of photonic crystals exhibiting no diffraction.

FIG. 1B is an illustration of the orientation of photonic crystals in the presence of a magnetic field, the photonic crystal chains align parallel to the field and diffract light, exhibiting a color dependent on the magnetite nanoparticle spacing and size of the photonic crystals within the chains in accordance with an exemplary embodiment.

FIG. 2 is an illustration of red photonic crystal chains with a blue dye to improve contrast in accordance with an exemplary embodiment.

FIG. 3 is an illustration of films in accordance with an exemplary embodiment.

### DETAILED DESCRIPTION

Reference will now be made in detail to the present preferred embodiments of the invention, examples of which are illustrated in the accompanying drawings. Wherever possible, the same reference numbers are used in the drawings and the description to refer to the same or like parts.

The present disclosure relates to systems and methods to produce and use encapsulated photonic crystals in solid films and or substrates. Such films and substrates containing capsules of photonic crystals can be employed where dynamic, responsive, or tunable color properties are desired. For example, but not limited to, color changing films for personal customization, coatings for location sensing such as in sports where a ball landed in relation to a boundary, or for reflective displays such as chemical free marking boards or full color range electronic ink screens.

In accordance with an exemplary embodiment, photonic crystals dispersed in a solvent are encapsulated in a material shell which acts as a barrier and protects the material-solvent dispersion from the solid phase mechanics and exterior environment. Microcapsules may be mixed with a range of film-formers or substrates, which can then be applied to an object if desired and dried or cured, trapping and further sealing the microcapsules in the hardened film or substrate.

In accordance with an exemplary embodiment, the encapsulated liquid dispersion of photonic crystals can be preserved allowing for the dynamic responsive and tunable color properties of the photonic crystals. Photonic crystals can be manipulated by an external stimulus which is defined as any force capable of activation of the photonic crystals (for example, magnetic or electric fields). The composition of the internal phase can vary widely for the purpose of tuning the behavior of the photonic nanomaterials including but not limited to response and relaxation time, color and color range, and stimuli specificity. Physical properties which have an effect on the behavior of photonic crystals may include viscosity, conductivity, refractive index, and polarity.

In accordance with an exemplary embodiment, the nanomaterials can be, for example, pea-pod structure chains of Fe₃O₄ nanoclusters coated by silica exhibiting a predetermined color when aligned based on the size and separation distance of Fe₃O₄ clusters within individual chains. (See, for example, Yin et al. J. Mater. Chem. C, 2013, 1, 6151, which is incorporated herein by reference in its entirety). These 1D photonic crystal chains can be turned “ON” and “OFF” by manipulating their orientation using an external energy source. When these chains are encapsulated and sealed into a solid film or substrate, the resulting material has sensing properties such that it can detect the presence of an energy source by exhibiting a localized, transient color change.

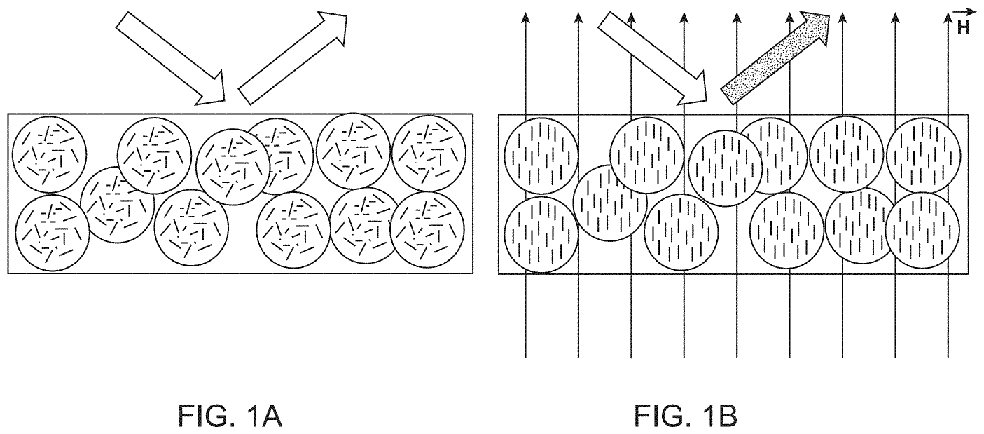

FIGS. 1A and 1B show the schematic representation of the diffraction of light off the surface of a film having encapsulated photonic crystal chains in both the equilibrium “OFF” state and the “ON” state in the presence of a magnetic field. FIG. 1A is an illustration of the equilibrium “off” state having a random orientation of photonic crystal chains exhibiting no diffraction. As shown in FIG. 1B, in the presence of an external source, for example, a magnetic field, the photonic crystal chains align parallel to the field and diffract light, exhibiting a color dependent on the magnetite nanoparticle spacing and size within the chains.

Depending on the selected viscosity and dispersant composition of the internal phase within the capsules, the localized color change may be permanent or recover to its equilibrium “OFF” state after some time, for example, seconds, minutes, or hours.

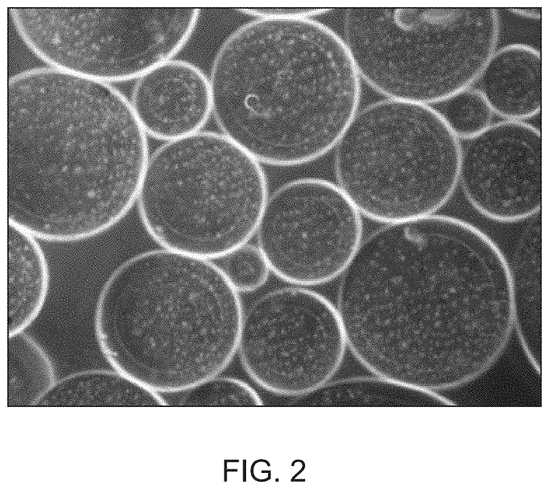

In accordance with an exemplary embodiment, the color of the equilibrium state of the encapsulated slurry/paint film may be adjusted by incorporation of dyes inside the photonic crystal chain's silica layer, the capsule, or the film-forming substrate. Adjustments to the equilibrium state color may also serve as a method of improving the contrast ratio between a localized “on” state and the surrounding “off” state colors. FIG. 2 shows capsules with dyes to improve contrast of the photonic crystal chains.

In accordance with an exemplary embodiment, the realized capsule slurry can be readily mixed with substrate precursors to impart the dynamic color property of the capsules to the substrate in question. Examples of substrate precursors can include film-forming solutions including water-based paints or drying polymers, curing substrates such as radical induced polymerization or heat treated thermoplastics, or incorporated into industrial production of materials such as fibers or elastomers. In accordance with an exemplary embodiment, the paint can be a water-based paint, for example, an acrylic paint.

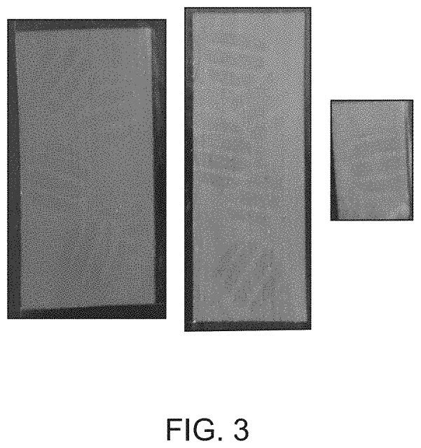

In accordance with an exemplary, the disclosure can be used as a marking paint. For example, in sports, a playing surface may be coated with a paint incorporating the capsules. The playing surface may then behave as a sensor, marking the location where contact by a specialized playing object (for example, a ball) has occurred, and then disappearing after a selected time interval. FIG. 3 shows photographs of samples of the dried marking paints with the visible marks. For example, since tennis can be a sport riddled with controversy involving boundary calls, tennis is one of the many sports that stands to benefit directly from this product. Other markets can also benefit from this technology such as drawing boards which are free from chemicals having a magnetic pen which never runs out of ink or degas solvents into the local environment.

### Methods

Encapsulation procedures:

### EXAMPLE 1

Non-polar core phase:

Silica surface of Fe₃O₄@SiO₂ photonic crystals are functionalized with octadecyltrimethoxysilane (ODTMS) by dispersing in a mixture of 12.5 mL ethanol and 0.5 mL 28-30% ammonium hydroxide solution in a sealed glass vial. 150 μL ODTMS is added while stirring and the temperature is raised to a reflux for 1.5 hours (hrs) with occasional sonication. The hydrophobic phonic crystals (HPCs) are magnetically separated and washed with hexanes. The HPCs are then dispersed in 1 mL of a surfactant mixture containing 9 wt % ashless dispersant (RB-ADS-1000) in light paraffin oil.

A pigment or dye can be added at this time to the core phase to modify the equilibrium state color as desired.

Encapsulation of core-phase by urea-formaldehyde capsules:

Dissolve 0.083 g resorcinol and 0.833 g urea into 25 mL 3.33 wt % poly(ethylene-alt-maleic anhydride) in water. Once dissolved, the solution is titrated to pH 3.35 by the addition of a 6 M sodium hydroxide solution. Under mechanical stirring at 450 rpm, 4 mL of the core phase solution is added and the mixture is allowed to emulsify for 10 minutes. Then, 2.27 mL of a 37% formaldehyde solution is added and the solution brought up to 55° C. over 60 minutes and held there for an additional 3 hours. The solution becomes white-turbid as urea-formaldehyde nanoparticles form and the urea-formaldehyde shells grow. Once the reaction is complete, the solution is diluted with water and the capsules are separated and washed several times with water until the microcapsule slurry is free of UF nanoparticles and excess surfactants.

The microcapsule slurry is concentrated and ready to be mixed with film forming material or solution as desired.

Photonic crystals have the potential to disrupt or at the very least support the traditional dyes and pigments industry. Dyes and pigments have inherent limitations as they undergo physical process to produce color which is susceptible to “bleaching” and the color will fade over time. Photonic crystals improve the lifetime of colors as the physical mechanism by which they produce color is fundamentally different and relies on light diffraction rather than light absorption. This diffraction mechanism is not susceptible to bleaching and therefore can drastically improve lifetime of colors and reduce fading. Furthermore, the photonic crystals possess unique color properties such that one material can be made to produce any number of colors across the light spectrum, which is not the case of dyes and pigments having specific colors and which must be mixed with each other to create additional colors. Some photonic crystals may be a disordered array of materials providing a flat color from all viewing angles or highly crystalline in nature and having colors dependent on the viewing angle. The latter, angular dependency allows for these crystals to be manipulated to tune and react to their environment and become a type of sensor. As described here, photonic crystals can be switched between an equilibrium “OFF” state and a bright colored “ON” state by rotating the crystals within the capsules using a magnetic field.

Encapsulation of materials or liquids is prevalent in industry and will continue to be for the foreseeable future. In accordance with an exemplary embodiment, the technique allows for controlled separation of two phases of liquids in order to accomplish some process or integration of materials which may not be readily combined. Prior art utilizing photonic crystals has employed encapsulation techniques in order to create photonic crystal spheres of a fixed color, or storage compartments for photonic crystal components/monomers, but not to preserve the suspended liquid state of photonic crystals so that they may remain active in a solid substrate, which is precisely what is demonstrated herein.

In accordance with an exemplary embodiment, a magnetic field responsive coating is disclosed that can include, for example, a single type of photonic crystal, nanochains, and having a range of fixed colors.

As used herein, an element or step recited in the singular and preceded by the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional examples that also incorporate the recited features.

The patent claims at the end of this document are not intended to be construed under 35 U.S.C. § 112(f) unless traditional means-plus-function language is expressly recited, such as “means for” or “step for” language being expressly recited in the claim(s).

It will be apparent to those skilled in the art that various modifications and variation can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for generating a dynamic and responsive color media, the method comprising:
encapsulating nanomaterials within a capsule to form encapsulated photonic crystals; and
dispersing the encapsulated photonic crystals within a film or substrate, wherein the encapsulated nanomaterials retain a liquid dispersion state and can move freely within the capsule and the capsules containing photonic crystals remain stationary within the film or substrate.

2. The method according to claim 1, further comprising:
applying an external energy source to the encapsulated photonic crystals to form one or more colors.

3. The method according to claim 1, wherein the film or substrate is a coating for location sensing or a reflective display.

4. The method according to claim 1, wherein the film or substrate is a boundary of an athletic court, the method further comprising:
changing a color of the boundary by exposing the film or substrate to a ball having an external energy source.

5. The method according to claim 4, wherein the nanomaterials exhibit a localized, transient color change when exposed to the external energy source.

6. The method according to claim 1, wherein the photonic crystals are pea-pod structure chains of Fe₃O₄ nanoclusters coated by silica exhibiting a predetermined color when aligned based on a size and separation distance of Fe₃O₄ clusters within individual chains.

7. The method according to claim 6, comprising:
functionalizing the silica surface of the Fe₃O₄@SiO₂ photonic crystals with octadecyltrimethoxysilane (ODTMS)

8. The method according to claim 1, wherein walls of the capsule are urea-formaldehyde.

9. The method according to claim 1, further comprising:
incorporating a colored dye inside the capsule comprising the photonic crystals to change a color of the photonic crystal in an equilibrium state.

10. The method according to claim 1, further comprising:
incorporating a colored dye inside the film or substrate to change a color of the photonic crystal in an equilibrium state.

11. The method according to claim 1, comprising:
a first state of equilibrium of the encapsulated photonic crystal having a random orientation of the photonic crystals exhibiting no diffraction; and
a second state of equilibrium of the encapsulated photonic crystals in the presence of a magnetic field, the photonic crystals align parallel to the field and diffract light, exhibiting a color dependent on the magnetite nanoparticle spacing and size within the chains.

12. The method according to claim 1, wherein the film or substrate film or substrate is a film-forming solution, thermoplastic material, and/or a fiber or elastomer.

13. The method according to claim 12, wherein the film-forming solution is a water-based paint or polymer.

14. A method for generating a dynamic and responsive color media, the method comprising:
dispersing a photonic material in a solvent, the photonic crystals being encapsulated in a material shell forming microcapsules, the material shell acting a as a barrier, which protects the photonic material-solvent dispersion from phase mechanics and an exterior environment;
mixing the photonic material-solvent dispersion with a film-former or substrate; and
applying the photonic material-solvent dispersion with the film-former or substrate to an object and drying or curing the photonic material-solvent dispersion with the film-former or substrate to seal the photonic material in a hardened film or substrate.

15. The method according to claim 14, further comprising:
preserving the encapsulated dispersion of photonic materials to allow for the dynamic responsive and tunable color properties of the photonic materials.

16. The method according to claim 14, comprising:
tuning the behavior of the photonic materials to include one or more of the following: response and relaxation time, color and color range, and stimuli specificity.

17. The method according to claim 14, comprising:
manipulating the photonic materials with an external stimulus, and wherein the external stimulus is a magnetic field or an electric field.

18. A system for generating a dynamic and responsive color media, the film or substrate comprising:
nanomaterials encapsulated within a capsule to form encapsulated photonic crystals; and
wherein the encapsulated photonic crystals are dispersed within a film or substrate, and wherein the encapsulated nanomaterials retain a liquid dispersion state and can move freely within the capsule and the capsules containing photonic crystals remain stationary within the film or substrate.

19. The system according to claim 18, comprising:
applying an external energy source to the encapsulated photonic crystals to form one or more colors.

20. The system according to claim 18, wherein the film or substrate is a coating for location sensing or a reflective display.

21. The system according to claim 18, wherein the film or substrate is a boundary of a tennis court, and wherein a color of the boundary is changed by exposing the film or substrate to a ball having an external energy source.

22. The system according to claim 21, wherein the nanomaterials exhibit a localized, transient color change when exposed to the external energy source.

23. The system according to claim 1, wherein the photonic crystals are pea-pod structure chains of Fe₃O₄ nanoclusters coated by silica exhibiting a predetermined color when aligned based on a size and separation distance of Fe₃O₄ clusters within individual chains.

24. The system according to claim 23, wherein the silica surface of the Fe₃O₄@SiO₂ photonic crystals is functionalized with octadecyltrimethoxysilane (ODTMS)

25. The system according to claim 18, wherein walls of the capsule are urea-formaldehyde.

26. The system according to claim 18, further comprising:
a colored dye incorporated inside the capsule comprising the photonic crystals to change a color of the photonic crystal in an equilibrium state.

27. The system according to claim 18, further comprising:
a colored dye incorporated inside the film or substrate to change a color of the photonic crystal in an equilibrium state.

28. The system according to claim 18, comprising:
a first state of equilibrium of the encapsulated photonic crystal having a random orientation of the photonic crystals exhibiting no diffraction; and
a second state of equilibrium of the encapsulated photonic crystals in the presence of a magnetic field, the photonic crystals align parallel to the field and diffract light, exhibiting a color dependent on the magnetite nanoparticle spacing and size within the chains.

29. The system according to claim 18, wherein the film or substrate film or substrate is a film-forming solution, thermoplastic material, and/or a fiber or elastomer.

30. The system according to claim 29, wherein the film-forming solution is a water-based paint or polymer.
